(19) United States
(12) Patent Application Publication
(10) Pub. No.: US 2016/0028592 A1
(43) Pub. Date: Jan. 28, 2016

(54) Information Processing System, Information Processing Method and Medium

(71) Applicant: FUJITSU LIMITED, Kawasaki-shi (JP)

(72) Inventors: Keiko Takeuchi, Kawasaki (JP); Akira Minegishi, Setagaya (JP)

(21) Appl. No.: 14/755,694

(22) Filed: Jun. 30, 2015

(30) Foreign Application Priority Data
Jul. 23, 2014 (JP) 2014-150197

(51) Int. Cl. H04L 12/24; G06F 3/0482

(52) U.S. Cl. CPC H04L 41/22; G06F 3/0482

(57) ABSTRACT

A program stored in the memory causes the processor to acquire one or more items of information from one or more connection interfaces each to access an information acquisition source within an information processing system at timing being set corresponding to each item. Further, the program causes the processor to display each item of the acquired one or more items information in a display field associated with each item of the acquired one or more items information. Yet further the program causes the processor to set the timing for acquiring the one or more items of information next corresponding to a characteristic per item of the acquired one or more items information.

### CROSS-REFERENCE TO RELATED APPLICATIONS

This application is based upon and claims the benefit of priority of the prior Japanese Patent Application No. JP2014-150197, filed on Jul. 23, 2014, the entire contents of which are incorporated herein by reference.

### FIELD

The embodiments discussed herein are related to an information processing apparatus, an information processing system, an information processing method and a program.

### BACKGROUND

Over the recent years, there has been utilized an information processing system configured by integrating and interconnecting information processing apparatuses and other devices via a network. A software product also appears, which is configured by integrating business-use applications or management software components for managing the information processing system. The software product configured by integrating the management programs or the business-use applications may also be called a vertical integration system product in the information processing system configured by integrating the information processing apparatuses and other devices.

### DOCUMENT OF PRIOR ART

### Patent Document

[Patent Document 1] Japanese Patent Application Laid-Open Publication No. 2004-178371

[Patent Document 2] Japanese Patent Application Laid-Open Publication No. H11-177611

[Patent Document 3] Japanese Patent Application Laid-Open Publication No. 2006-035818

[Patent Document 4] Japanese Patent Application Laid-Open Publication No. 2000-259520

[Patent Document 5] International Application Publication WO2011/064812

### SUMMARY

One aspect disclosed in the embodiment is exemplified by an information processing apparatus that follows. To be specific, the information processing apparatus includes a processor, and a memory storing a program. The program stored in the memory causes the processor to acquire one or more items of information from one or more connection interfaces each to access an information acquisition source within an information processing system at timing being set corresponding to each item. Further, the cause the processor to display each item of the acquired one or more items information in a display field associated with each item of the acquired one or more items information. Yet further the program causes the processor to set the timing for acquiring the one or more items of information next corresponding to a characteristic per item of the acquired one or more items information.

The object and advantage of the embodiment will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating a logical topology of an information processing system according to a comparative example;

FIG. 2 is a diagram illustrating a specific configuration of the information processing system according to the comparative example;

FIG. 3 is a diagram illustrating a management module and an interface to the management module.

FIG. 4 is a diagram illustrating a logical configuration of the information processing system according to an embodiment;

FIG. 5 is a diagram illustrating a configuration of a management screen on a GUI;

FIG. 6 is a diagram illustrating a hardware configuration of a management apparatus;

FIG. 7 is a diagram illustrating a detailed configuration of an API;

FIG. 8A is a diagram illustrating data in an information table;

FIG. 8B is a diagram illustrating data in an information table;

FIG. 9A is a flowchart illustrating whole processes of the management apparatus;

FIG. 9B is a flowchart illustrating whole processes of the management apparatus;

FIG. 10 is a flowchart illustrating details of processes of a data acquiring unit;

FIG. 11 is a flowchart illustrating a procedure for learning an update interval.

FIG. 12 is a flowchart illustrating a procedure for learning the update interval;

FIG. 13 is a flowchart illustrating a process of acquiring information at a fixed interval.

FIG. 14 is a flowchart illustrating details of a screen update process;

FIG. 15 is a flowchart illustrating processes when starting up an application.

### DESCRIPTION OF EMBODIMENT(S)

In an information processing system exemplified by a vertical integration system product, the information processing apparatus to execute processes instanced by managing the information processing system and other equivalent processes, acquires items of information from a variety of layers instanced by a physical layer, a virtual layer, an OS layer and other equivalent layers of the information processing system. However, when the information processing apparatus acquires the information from information acquisition sources on the variety of layers of the information processing system, response time till acquiring the information differs due to accesses via, e.g., difference interfaces. As a result, a screen update process of outputting the information acquired by the information processing apparatus to a screen and other equivalent components, is not executed at proper timing as the case may be.

According to one aspect disclosed in an embodiment, information is acquired and displayed smoothly at desired timing from each information acquisition source in an information processing system including a plurality of information acquisition sources.

An information processing system according to one embodiment will hereinafter be described with reference to the drawings.

### Comparative Example

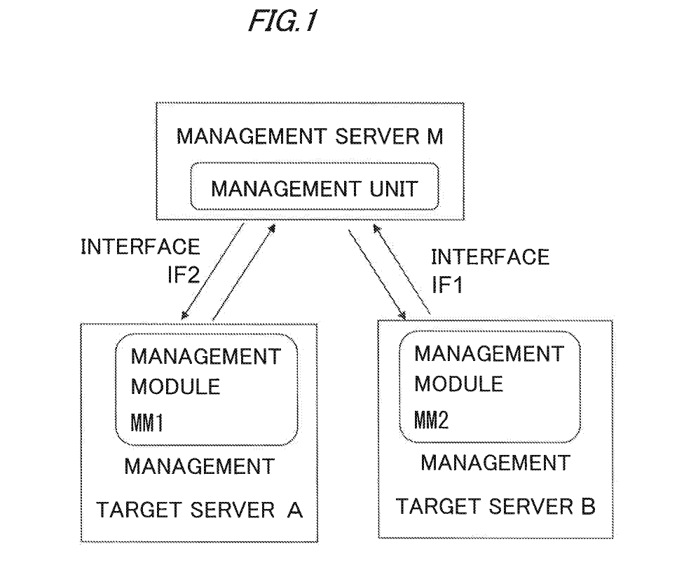

The information processing system according to a comparative example will be described with reference to FIGS. 1 through 3. FIG. 1 is a diagram illustrating a logical topology of the information processing system according to the comparative example. The information processing system in the comparative example includes, as in FIG. 1, a management server M and management target servers A, B and other equivalent servers that are managed by the management server M. FIG. 1 depicts the two management target servers A and B, however, it does not mean that a number of management target servers is limited to “2”. For example, the management server and the management target server may also be the same single server. Further, one single management target server may also be available in addition to the management server M. Still further, three or more management target servers may also be provided.

The management server M executes a management program on a main storage, and thus provides processes for a management unit to manage the management target servers A, B and the management server M itself. The management unit accesses the management target servers A, B and the management server M itself via a variety of APIs (Application Interfaces) (Application Programming Interfaces), thereby acquiring information. Then, the management unit provides a user with the information acquired in, e.g., a management screen format.

More concretely, the management unit executes a screen update process upon pressing down, e.g., an update button on a management screen of the management server M. To be specific, the management unit notifies, of a query, the management target servers A, B or a management module of the management server M itself by using each connection I/F defined by the API with respect to each of display items on the management screen, thus acquiring the information.

The example in FIG. 1 is that the management unit accesses a management module MM1 of a management target server A by use of an IF2 serving as the connection I/F via the API. The management module MM1 is herein one example of a management module on a server. The management module MM1 includes a CPU, a memory and other equivalent devices for the management process, and is equipped with operation management functions instanced by monitoring a status of hardware, outputting configuration information, outputting error information, managing partitions, managing the network and controlling a power source.

The management unit accesses a management module MM2 of a management target server B by use of an IF1 as the connection I/F via the API. The management module MM2 may be exemplified by a BMC (Baseboard Management Controller). The BMC is a standard management module pursuant to IPMI (Intelligent Platform Management Interface) standards, and performs monitoring the status of the hardware, switching ON/OFF the power source and other equivalent operations.

The interfaces IF, IF2 to the management modules MM1, MM2 may be exemplified by several interfaces including an IPMI (Intelligent Platform Management Interface) and an SNMP (Simple Network Management Protocol). Note that other connection I/Fs to, e.g., OS (Operating System) may be exemplified by several interfaces including a VIAPI (VMware Infrastructure Application Programming Interface) and a WMI (Windows Management Instrumentation (Windows is a registered trademark).

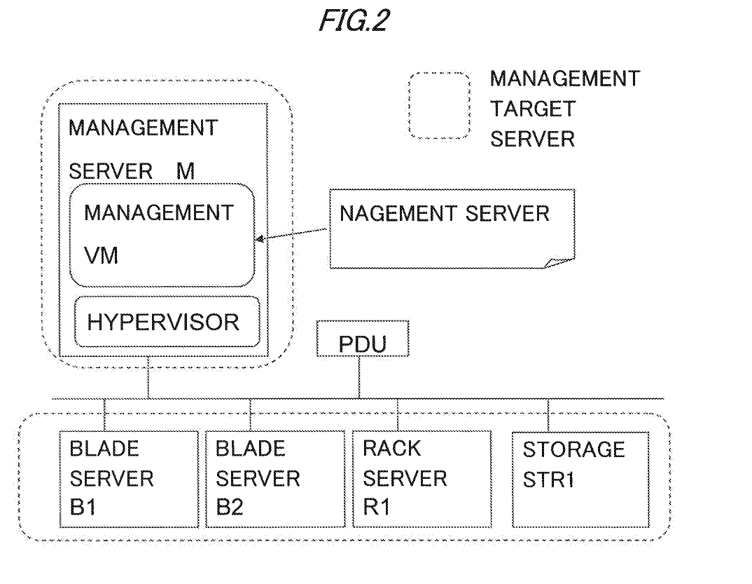

The management unit provides the user with the information acquired from the management modules of the respective servers of the information processing system illustrated in, e.g., FIG. 2, the information taking the management screen format. The information to be acquired by the management unit is acquired from a variety of layers instanced by several layers including a physical layer, a virtual layer and an OS layer. For example, upon the user's pressing down the update button on the management screen, the management unit issues an information acquiring instruction to the API as triggered by detecting the press-down on the update button. The API sequentially issues the information acquiring instruction to the connection I/F. Then, the management unit updates the management screen after completing the acquisition of the entire information from the API.

FIG. 2 illustrates an example of a specific configuration of the information processing system in the comparative example. The information processing system in FIG. 2 includes the management server M, blade servers B1, B2, a rack server R1, a storage STR1 and a PDU (Power Distribution Unit). The respective servers and the PDU in FIG. 2 are interconnected via a network. The management target server is the blade server B1 or the PDU in the example of FIG. 2. The respective servers have, though omitted in FIG. 2, the same management modules MM1 (MM2, . . . ) as illustrated in FIG. 1. The PDU is a plug socket configured to enable usage power, a temperature and other equivalent data to be measured.

The management server M executes the management program by a management VM (Virtual Machine) on, e.g., a hypervisor, thereby providing the processes for the management unit. To be specific, the management unit acquires the information from the management server M itself, the management target server connected to the network and the PDU, and provides the user with the acquired information in the management screen format. For example, the management unit, upon pressing down the update button on the management screen, queries the hardware or the OS via the API, and thus acquires the information. Then, the management unit updates the management screen just when all items of information on the management screen can be acquired.

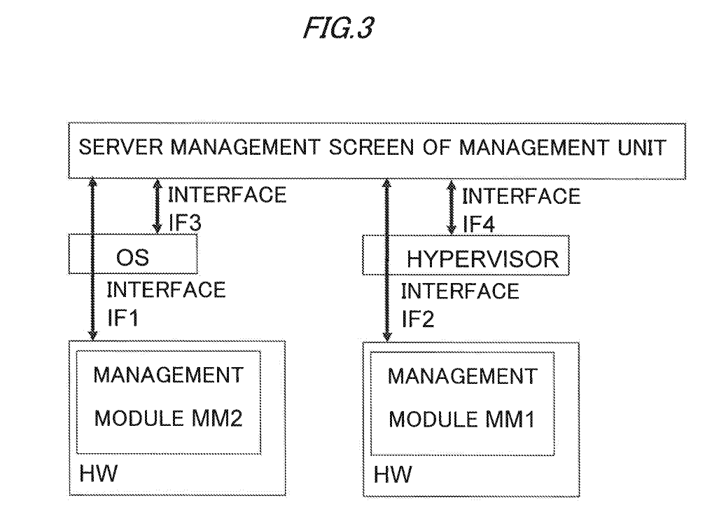

FIG. 3 illustrates interfaces to the management modules MM1, MM2 and other equivalent modules. For example, the management unit sequentially issues the information acquiring instruction to the information acquiring target via each connection I/F upon detecting the press-down on the update button. For instance, the management unit accesses the OS via the interface IF3, and also accesses the management module MM2 of the management target server by use of the interface IF1. The management unit accesses the virtual layer and other equivalent layers via the interface IF4, and also accesses the management module MM1 of the management target server by using the interface IF2. Then, the management unit acquires the information from the respective management modules when communicable with those management modules, and displays the acquired information on the management screen.

However, the management unit, when acquiring the information from the variety of layers, acquires the information via, e.g., the different connection I/Fs, and therefore response time for acquiring the information differs. The management unit may update the screen corresponding to, e.g., the information acquired latest. In other words, the management unit waits for a value acquired last time and may output the values of various items of information to the management screen. However, a timeout occurs because, for example, some items of information cannot be acquired, in which case the management unit waits for a consequence that the timeout will have occurred about items of information which are not acquired even when some items of information have been acquired earlier. Thus, the management unit outputs the consequence of reaching the timeout to the screen. The information processing system according to the comparative example described above has the following aspects.

(Aspect 1)

The screen is fixed due to a load on the resource of the information processing system, and an update status is not smoothly displayed in some cases. For example, the management unit in the comparative example, when carrying out the update upon receiving an update request from the user pressing down the update button, updates all of display fields on the screen. The management unit therefore executes a process of acquiring one set of information corresponding to the management screen. The update process occupies the connection I/F, and a substantially large load is applied to the resources instanced by the CPU, the memory and the network in some cases. Such being the case, the result is that the screen is fixed, and the update status is not smoothly displayed.

(Aspect 2)

A considerable period of time is expended for updating the management screen as the case may be. For example, the timeout occurs when the communication of the connection I/F is disabled. The management unit waits for a response till timeout time when the timeout occurs due to the communication being disabled. The management unit in the comparative example updates again all of the items when updating the screen. The management unit therefore waits for the timeout about the communication-disabled connection I/F as well. The management unit consequently requires the time for completion of collecting the information, resulting in taking a considerable period of time till completely updating the screen.

As described above, the information processing system including the variety of layers has different lengths of time expended for acquiring the information, depending on the connection I/Fs to acquire the information from the respective layers. However, the management unit updates all items of information at one time when updating the screen, and therefore updates the screen in a way of being adjusted to the item with the response being given late also about the items with the information being acquired at an early stage. The management unit takes the time for updating the screen because the information acquired by using, e.g., the SNMP stands by till completing the acquisition of the information obtained via the VIAPI.

The management unit, when using the connection I/F requiring authentication, waits till completing the acquisition of the information due to the time being taken for the authentication. For example, the VIAPI requests the management unit to approve a user name and a password when acquiring the information, i.e., when the management unit connects to the VIAPI. The VIAPI has a longer period of time till completing the acquisition of the information than by the SNMP to establish the connection by use of a community name.

(Aspect 3)

The information processing system in the comparative example has a one-to-one correspondence between the connection I/F and each item of information on the management screen. The information cannot be therefore acquired when the connection I/F corresponding to the item on the management screen is disabled from establishing the connection. For example, the management screen displays some items (instanced by a manufacturing model and other equivalent items) which are acquired from the management module MM1 via the interface IF2. On the other hand, there exists a substitute I/F enabled to acquire the same information, for example, the interface IF1 is usable for the management module MM2 to acquire the same information.

However, the management unit in the comparative example has the one-to-one correspondence between each of the items on the management screen and the connection I/F. The management unit in the comparative example therefore sets the management screen in a “communication-disabled” status when the information cannot be acquired from one connection I/F in spite of a point that the information can be acquired via another connection I/F.

The following embodiment proposes a control technology of providing improvements for updating the information on the management screen and acquiring the information in the management unit of the information processing system exemplified in the comparative example discussed above.

### Embodiment

### Configuration

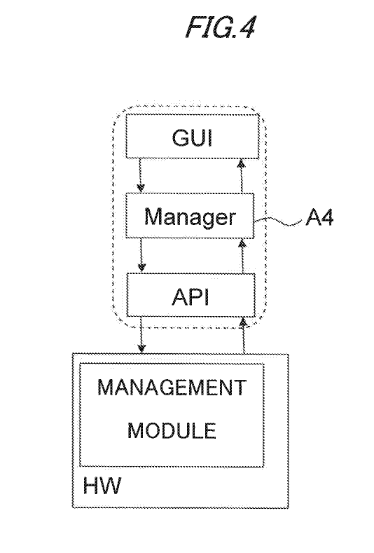

The information processing system according to an embodiment will hereinafter be described with reference to the drawings. FIG. 4 is a diagram illustrating a logical configuration of the information processing system. The information processing system includes a GUI (Graphical User Interface), a manager (Manager) A4, an API (Application Programming Interface) and a management module as in FIG. 4. A management apparatus in the information processing system is configured to include the GUI, the manager A4 and the API in FIG. 4. The management apparatus is exemplified by one server or an information processing apparatus included in the information processing system. The management apparatus may, however, be a dedicated management computer that manages the information processing system. The management apparatus may also exist on a virtual machine including a guest OS and the virtual layer instanced by the hypervisor and other equivalent virtual programs.

The management apparatus collects various items of information from the devices instanced by the blade server, the rack server and other equivalent devices included in the management target information processing system, and displays the collected items of information on the management screen running on the GUI. The management module is an on-board server management chip or a unit dedicated to the server management, and other equivalent hardware.

The API collects the information by accessing the management module via the connection I/F instanced by the interfaces IF1-IF4. The collected information is handed over the manager A4. The manager A4 outputs the information acquired from the management module via the API to the management screen on the GUI. More specifically, the manager A4 queries the management module via the connection I/F by invoking an API's function, thus acquiring the information. The API acquires the information at proper timing in accordance with characteristics of the connection I/F and the management module in the embodiment. The API hands over the information to the manager A4 so as to reduce the load on the information processing system to outputs the management screen on the GUI. The manager A4 then outputs the information handed over from the API to the management screen on the GUI.

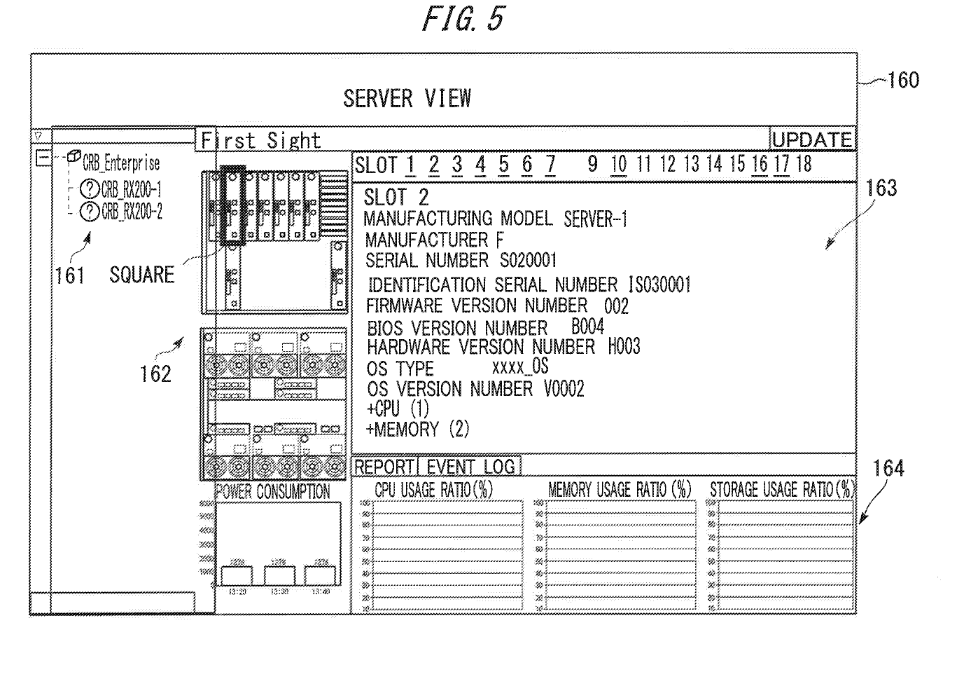

FIG. 5 illustrates a configuration of a management screen 160 on the GUI. The management screen 160 is one example of a screen. The management screen 160 includes a topology display unit 161, a hardware appearance display unit 162, a system information display unit 163 and a status display unit 164. The topology display unit 161 displays the configuration of the target information processing system to be managed by the management apparatus together with a topology taking a tree structure. To be specific, the topology display unit 161 displays hardware names instanced by server names and other equivalent names, and also the topology between the hardware components specified by the hardware names instanced by the server names, which are included in the information processing system.

The hardware appearance display unit 162 indicates external appearances, e.g., configurations of external appearances of front and rear surfaces of the hardware of the information processing system. The hardware appearance display unit 162 displays, when the hardware name of one server or other equivalent servers is selected in the topology display unit 161, a rectangular mark (SQUARE) in a position on the external appearance of the hardware corresponding to the selected hardware name, e.g., in a position of a slot 2.

The system information display unit 163 displays the various items of information acquired by the manager A4 via the API (connection I/F) from the management module MM1 and other equivalent modules. The items of information displayed by the system information display unit 163 are, e.g., a manufacturing model, a manufacturer, a serial number, a firmware version number, a BIOS (Basic Input/Output System) version number, a hardware version number, an OS type, an OS version number and other equivalent information. The status display unit 164 displays statuses of the information processing system as instanced by power consumption, a CPU usage ratio, a memory usage ratio, a storage usage ratio and other equivalent statuses.

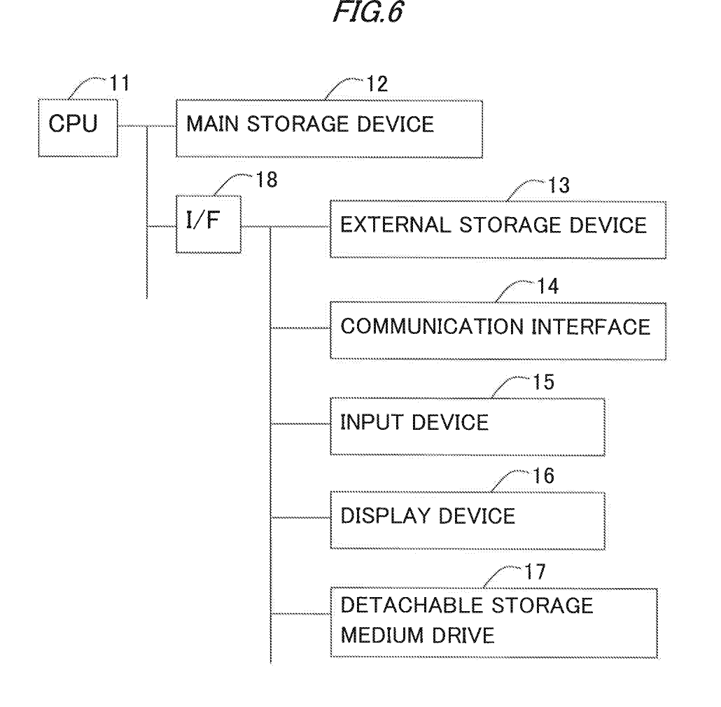

FIG. 6 is a diagram illustrating a hardware configuration of the management apparatus. The management apparatus includes, as in FIG. 6, a Central Processing Unit (CPU) 11, a main storage device 12 and external devices connected via an interface, and executes information processing based on a program. The external devices may be exemplified by an external storage device 13 and a communication interface 14. The CPU 11 provides the processes for the management apparatus by executing the computer program deployed in an executable manner on the main storage device 12. The main storage device 12 stores the computer program to be executed by the CPU 11 and data or other equivalent information to be processed by the CPU 11. The main storage device 12 is exemplified by a Dynamic Random Access Memory (DRAM), a Static Random Access Memory (SRAM), a Read Only Memory (ROM) and other equivalent memories. The external storage device 13 is used as a storage area auxiliary to, e.g., the main storage device 12, and stores the computer program to be executed by the CPU 11 and the data or other equivalent information to be processed by the CPU 11. The external storage device 13 is a hard disk drive, a Solid State Disk (SSD) and other equivalent storage devices.

The management apparatus may have a user interface using an input device 15, a display device 16 and other equivalent devices. The input device 15 is exemplified by a keyboard, a pointing device and other equivalent devices. The display device 16 is exemplified by a liquid crystal display, an electroluminescence panel and other equivalent display devices. The management apparatus may also be provided with a detachable storage medium drive 17. A detachable storage medium is exemplified by a Blu-ray disc, a Digital Versatile Disk (DVD), a Compact Disc (CD), a flash memory card and other equivalent mediums. Note that plural types of interfaces may be provided as interfaces 18, though FIG. 6 illustrates the single interface 18 by way of an example.

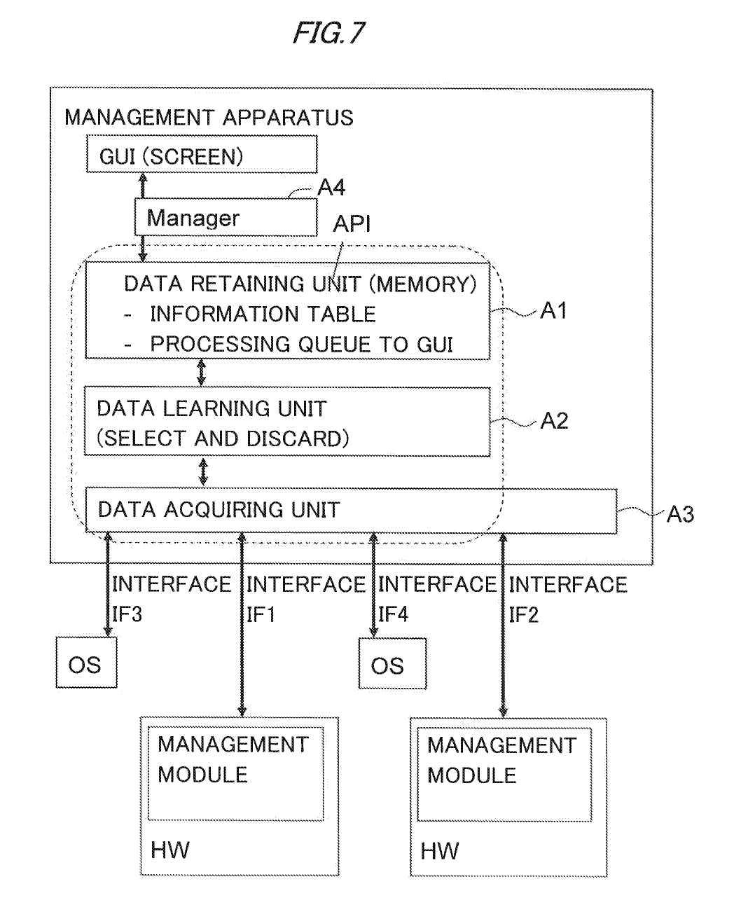

FIG. 7 illustrates a configuration of the management apparatus. The management apparatus includes the GUI to output the management screen, the manager A4 to set the information in the GUI, and the API to acquire the information set in the GUI by the manager A4. FIG. 7 illustrates a detailed configuration of the API. The API includes a data retaining unit A1, a data learning unit A2 and a data acquiring unit A3 as in FIG. 7. The data retaining unit A1 among these components is a cache retaining the data to be used by the management apparatus. The data retaining unit A1 is formed in the memory or a fast accessible device instanced by the SSD. The management apparatus in the embodiment retains, e.g., a variety of parameters related to the information acquired from the management modules and present values etc. of the information acquired from the management modules in a table called an information table, where the parameters are related to the items of information to be output to the management screen, i.e., the information acquired from the management modules. The data retaining unit A1 stores the information table. Note that the items of information acquired by the data acquiring unit A3 from the management modules are sorted out beforehand and retained in the information table. An initial value of an acquisition time interval, at which each item of information is acquired, is set in each item of the information table. The information table contains definitions of the connection I/F and the substitute I/F for acquiring the items of information.

The data learning unit A2 learns what characteristics are possessed by the acquisition target in cooperation with the data retaining unit A1, and determines a parameter related to timing of issuing a data acquiring instruction. Note that the acquisition time interval is one example of a parameter. To be specific, the data learning unit A2 learns what tendency and characteristics are possessed by the information acquired from the management module. The data learning unit A2 sets the parameter defined as a learnt result in the information table of the data retaining unit A1. The data learning unit A2 is one example of a setting unit.

The data acquiring unit A3 issues the information acquiring instruction to each connection I/F set in the information table according to the parameter given from the data learning unit A2, thereby acquiring the information from the management module. The data acquiring unit A3 sets the acquired information in the information table. When unable to use the connection I/F, however, the data acquiring unit A3 acquires the information via the substitute I/F.

The data acquiring unit A3 acquires the information from the management module provided in the management target OS or the management target hardware via the connection I/F exemplified by several interfaces including the interfaces IF1, IF2, IF3, IF4. The interfaces IF1, IF2, IF3, IF4 and other equivalent interfaces are herein the WMI, the IPMI, the VIAP, the SNMP and other equivalent interfaces or protocols. The management module is the same as the modules MM1, MM2 and other equivalent modules explained in FIG. 1. In other words, the management module includes the CPU, the memory and other equivalent components used for the management process, and is equipped with operation management functions instanced by monitoring the hardware status, outputting configuration information, outputting error information and performing partition management, network management and power control. The management target hardware is exemplified by the information processing apparatuses, e.g., the computers like the blade server and the rack server, the storage, the PDU and other equivalent units illustrated in FIG. 2 within the information processing system.

The data acquiring unit A3 sets the acquired items of information in information acquisition value fields of the information table, and selects necessary items of information but discards unnecessary items of information from the acquired information. For example, when the acquired information has a difference from the present value acquired last time, the data acquiring unit A3 sets a change flag in a change flag field of the information table. The data learning unit A2 sets, in a processing queue of the GUI, the information acquisition value of the item with the change flag being set. The manager A4 acquires the information from the processing queue of the GUI, and displays the acquired information on the management screen running on the GUI.

Each of the interfaces IF1, IF2, IF3, IF4 and other equivalent interfaces is one example of a connection I/F. The management module is one example of an information acquisition source. The data acquiring unit A3 is one example of a setting unit. The manager A4 is one example of a screen control unit.

Note that the CPU 11 of the management apparatus executes the computer program deployed in the executable manner on the main storage device 12 and the CPU 11 executes processes as GUI, the manager A4 and the API. At least a part of the manager A4 may, however, be a hardware circuit. Further, at least a part of any one of the data retaining unit A1, the data learning unit A2 and the data acquiring unit A3 included in the API in FIG. 7 may also be the hardware circuit.

<Data Example of Information Table>

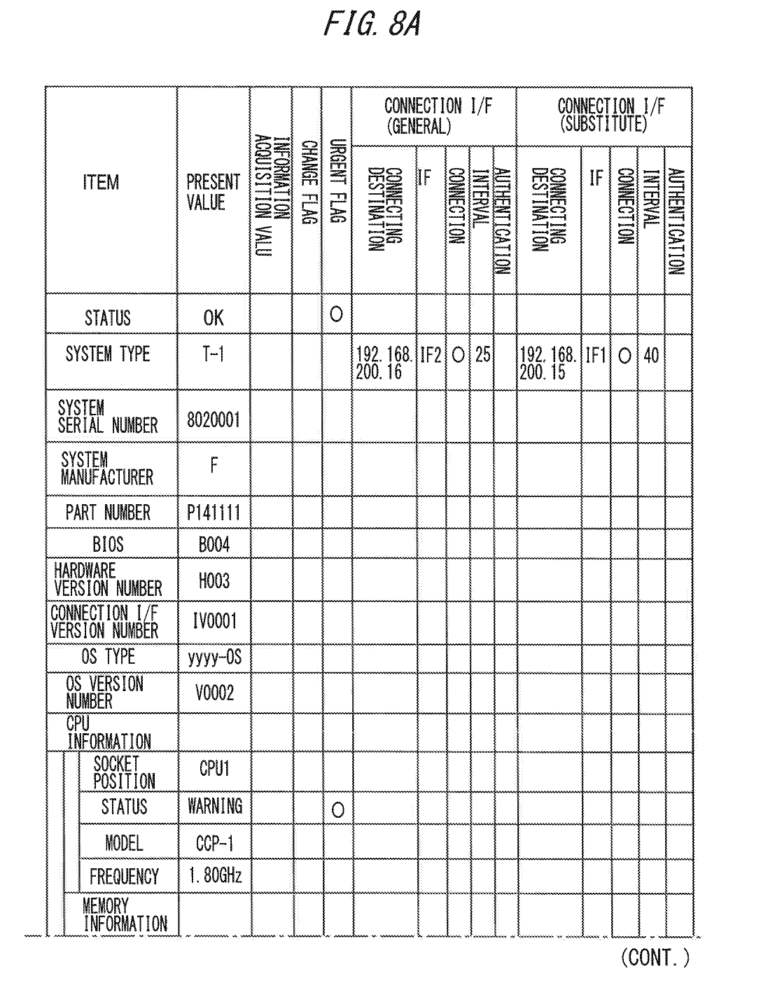

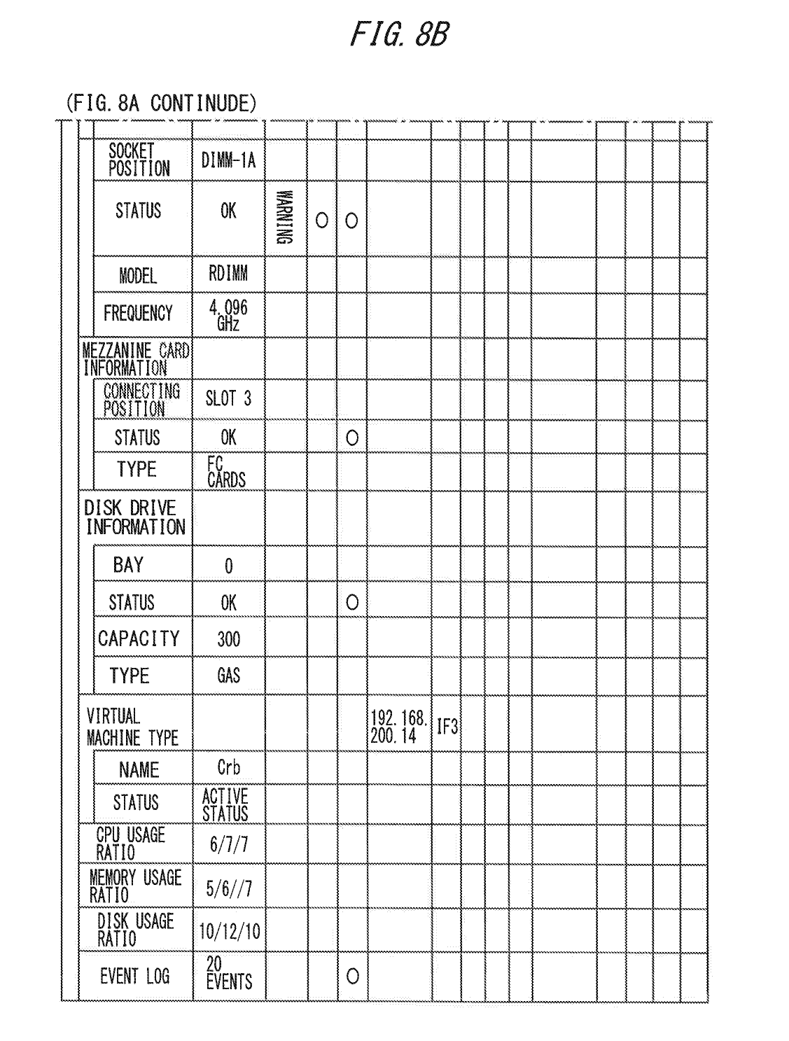

FIG. 8 illustrates data of the information table. An “item” field provided in a leftmost column of the information table in FIG. 8 contains names of the items as explanatory items in the information table. It does not, however, mean that the information table stored in the data retaining unit A1 retains each name corresponding to the “item”. The items provided in the information table are, as illustrated in FIG. 8, instanced by a status, a system type, a system serial number, a system manufacturing number, a part number, a BIOS version number, a connection I/F version number, an OS type, an OS version number and other equivalent data. The items provided in the information table are further instanced by CPU information, memory information, mezzanine card information, disk drive information, a virtual machine type, a CPU usage ratio, a memory usage ratio, a disk usage ratio, an event log and other equivalent data. The respective items are associated with individual rows in the information table as in FIG. 8.

Each item (each row) of the information table has a “present value” field, an “information acquisition value” field, a “change flag” field, an “urgent flag” field, and a “connection I/F” field. The present value is a value acquired from the management module via the connection I/F in the past and displayed on the management screen of the GUI at the present. The information acquisition value is a value acquired by the data acquiring unit A3 via the connection I/F but is not yet displayed on the management screen of the GUI. The information acquisition values in the respective items in FIG. 8 are one example of information.

The change flag is a flag indicating that the value acquired by the data acquiring unit A3 is different from the present value. FIG. 8 depicts the change flag in circle. However, a value of the change flag retained actually in the information table stored in the data retaining unit A1 may be a 1-bit value instanced by “0” (not changed) or “1” (changed). The urgent flag indicates information of the item having urgency. FIG. 8 depicts the urgent flag in circle. However, a value of the urgent flag retained actually in the information table stored in the data retaining unit A1 may be a 1-bit value instanced by “0” (not urgent) or “1” (urgent). The item with “urgent” being set is herein excluded from, e.g., a learning target of the time interval for acquiring the information and other equivalent targets, and the information of this item is preferentially acquired.

The “connection I/F” has definitions of the connection I/Fs for acquiring the information of the respective items. The “connection I/F” field is separated into a “connection I/F (general)” field and a “connection I/F (substitute)” field in FIG. 8. The “connection I/F (general)” field has an entry of the connection I/F to be accessed generally at first by the data acquiring unit A3. On the other hand, the “connection I/F (substitute)” is the connection I/F to be accessed by the data acquiring unit A3 when the connection I/F (general) is unable to establish the connection. Each of the “connection I/F (general)” field and the “connection I/F (substitute)” field has a “connecting destination” subfield, an “IF” subfield, a “connection” subfield, an “interval” subfield and an “authentication” subfield. The connection I/F (general) and the connection I/F (substitute) are one example of an acquisition path being configured redundant.

The connecting destination is herein information for specifying the management module to acquire the information. The connecting destination may be defined by use of, e.g., an IP (Internet Protocol) address. It does not, however, mean that the definition of the connecting destination is limited to the IP address. For example, the connecting destination may involve using a MAC address, a node name and other equivalent identifying information defined between the API and the management module.

The “IF” subfield defines the connection I/F to the management module. Note that though character strings instanced by IF1, IF2, IF3 and other equivalent character strings are set as “IF”, numbers corresponding to IF1, IF2, IF3 and other equivalent character strings may also be designated. For example, It may be sufficient that the interface IF1 is designated by a number “1”, and the interface IF2 is designated by a number “2”. The “connection” subfield has an entry of information indicating whether the connection is already established at the present. The “the connection being already established” is designated by the circle in FIG. 8 and may also be designated by a bit “1”. The “interval” subfield has an entry of the interval at which the data acquiring unit A3 acquires the information from the management module via the connection I/F. The “authentication” subfield has an entry of information indicating whether the connection I/F requires authentication. For example, the bit “1” designates that the authentication is required. While on the other hand, the bit “0” designates the authentication not being required.

<Processing Flow>

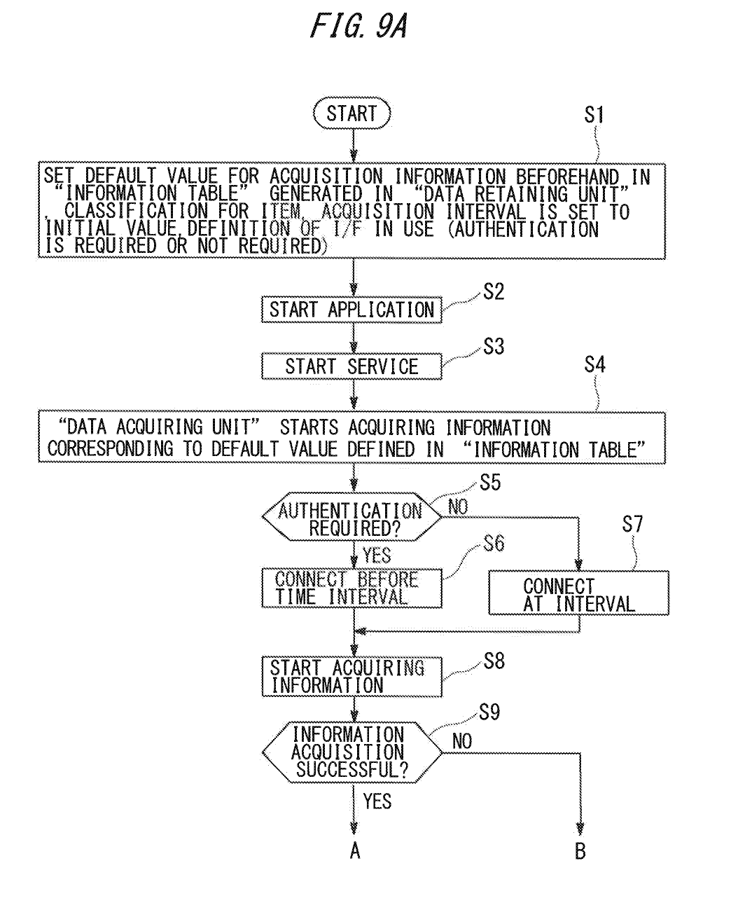

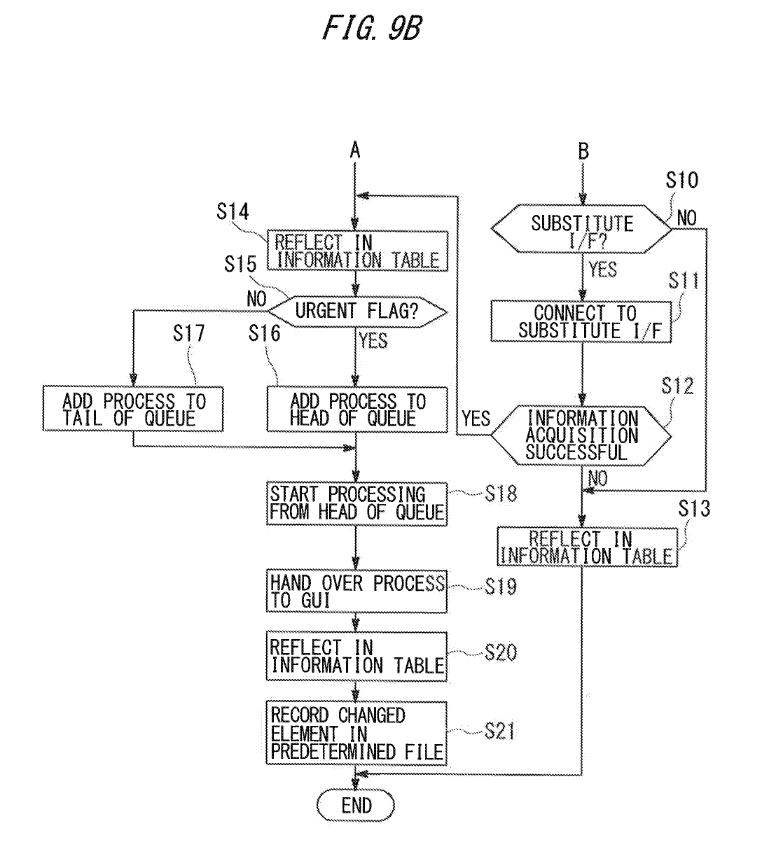

FIG. 9 illustrates an entire processing flow of the management apparatus. The CPU 11 of the management apparatus in this process sets a default value in the information table generated in the data retaining unit A1 (S1). The information acquired from the management module via the connection I/F is itemized and thus set as described in FIG. 8. The default value set in S1 is an initial value used in, e.g., the API.

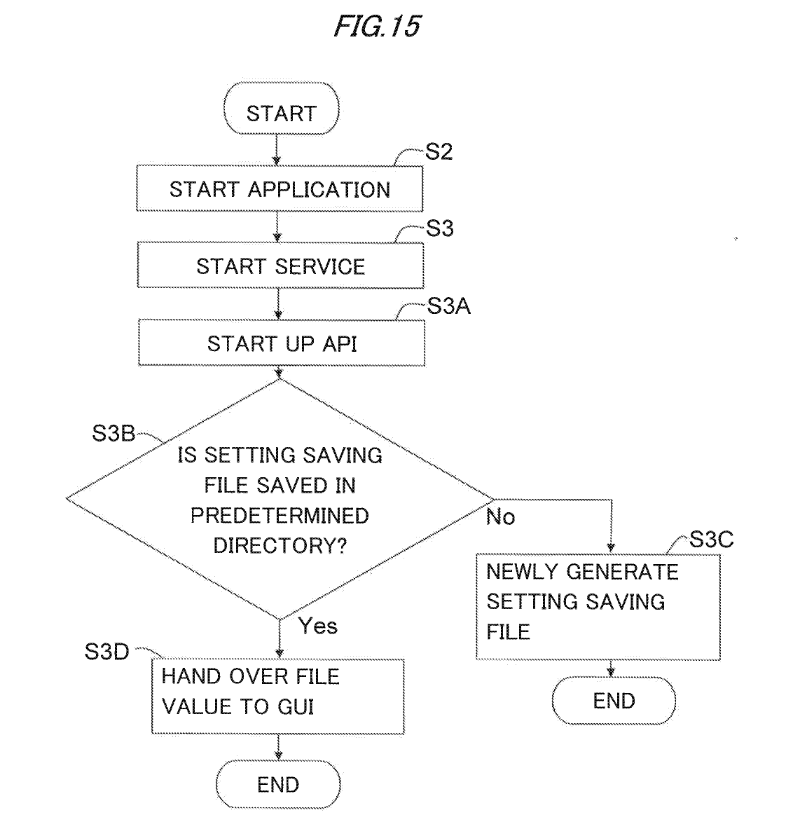

The CPU 11 of the management apparatus starts applications (S2). The CPU 11 of the management apparatus further starts services (S3). The application includes the GUI, the manager A4 and an API program invoked from the manager A4, and runs to display the management screen on the GUI. The process in S3 includes an initializing process of the API. The initializing process of the API involves rewriting the default value of the information table according to contents of, e.g., a setting condition file when the setting condition file exists. The initializing process of the API further involves rewriting the initial value (default value) of the information table according to the contents of, e.g., the setting condition file. The initializing process of the API will be separately described in detail in FIG. 15.

The data acquiring unit A3 of the management apparatus executes the following processes per item of the information table. To be specific, the data acquiring unit A3 of the management apparatus starts an information acquiring process in accordance with the default value defined in the information table (S4). The data acquiring unit A3 of the management apparatus normally accesses the general connection I/F at the time interval set in the “interval” field of the information table. When the connection I/F or the management module accessed from the connection I/F requires the authentication, however, the data acquiring unit A3 implements the authentication beforehand. This being the case, the data acquiring unit A3 refers to the information table and thus determines whether or not the connection I/F to the management module as the connecting destination requires the authentication when accessed (S5).

When requiring the authentication, the data acquiring unit A3 connects to the management module via the connection I/F before given time earlier than the connection timing based on the time interval specified in the “interval” field of the information table (S6). Whereas when not requiring the authentication, the data acquiring unit A3 connects to the management module via the connection I/F at the connection timing based on the time interval specified in the “interval” field of the information table (S7). Then, the data acquiring unit A3 starts acquiring the information from the general connection I/F (S8). The data acquiring unit A3 executes the processes in S5-S7 by way of one example of a process of completing authentication for an acquisition path.

As discussed above, the data acquiring unit A3 of the management apparatus generates, after starting up the application, the information table when starting the service irrespective of whether the management screen is displayed on the GUI, and starts collecting the information. The data acquiring unit A3 executes the processes in S5-S8 by way of a process of acquiring respective items of information at update timing corresponding to classification.

The data acquiring unit A3 determines next whether successful acquisition of the information is attained (S9). The successful acquisition of the information implies that the information is handed over from, e.g., the connection I/F but that an error code and other equivalent information are not handed over. While on the other hand, unsuccessful acquisition of the information implies that the timeout time elapses without any handover of the information from, e.g., the connection I/F. Alternatively, the unsuccessful acquisition of the information may include an implication that the error code is handed over from, e.g., the connection I/F.

When failing in acquiring the information, the data acquiring unit A3 determines whether the substitute I/F is defined or not (S10). When the substitute I/F is not defined, the data acquiring unit A3 reflects, in the information table, a connection-disabled status of the general connection I/F, i.e., the connection I/F from which to start acquiring the information in S8 (S13), and the processing is ended.

Whereas when determining in S10 that the substitute I/F is defined, the data acquiring unit A3 connects to the substitute I/F (S11). Then, the data acquiring unit A3 determines whether the information is successfully acquired from the substitute I/F or not (S12). When the data acquiring unit A3 does not successfully acquire the information from the substitute I/F, the processing advances the processing to S13 and is ended. The data acquiring unit A3 executes the processes in S9-S13 by way of one example of a process about the acquisition path being configured redundant.

When determining in S12 that the data acquiring unit A3 successfully acquires the information from the substitute I/F, the data acquiring unit A3 reflects the acquired information in the information table (S14). For example, the data acquiring unit A3 sets the acquired value in the “information acquisition value” field associated with the concerned item in the information table. The data acquiring unit A3 further determines whether the acquired value is coincident with a value registered in the “present value” field in the information table. When the two values are not coincident with each other, the change flag is set ON (circle, bit “1” and other equivalent indications). Upon the change flag being set ON, the data learning unit A2 determines that the value in the “information acquisition value” field is changed, and reads the changed value from the “information acquisition value” field.

The data acquiring unit A3 may, however, set the information acquisition value, corresponding to the determination of whether the two values are coincident in place of setting the change flag. It may be sufficient that the data acquiring unit A3, e.g., sets the acquired value in the “information acquisition value” field of the information table when the acquired value is not coincident with the value registered in the “present value” field of the information table, but does not set the acquired value in the “information acquisition value” field of the information table when the two values are coincident. The data learning unit A2 may determine that the information remains unchanged when “Blank” or “NULL data” or other equivalent information is registered in the “information acquisition value” field of the information table. The data acquiring unit A3 executes the processes in S4-S14 by way of one example of an information acquiring unit. The data acquiring unit A3 further executes the processes in S4-S14 by way of one example of a process of acquiring the information without depending on whether a screen is displayed.

The data learning unit A2 executes the processes from S14 onward. The data learning unit A2 determines whether the urgent flag in the information table is set or not (S15). When the urgent flag is set in the item having an active status of the processing in the information table, the data learning unit A2 adds the process to a head of a queue (S16). The item with the urgent flag being set ON is preferentially processed through the processes in S15, S16. Whereas when the urgent flag is not set in the item having the active status of the processing in the information table, the data learning unit A2 adds the process to a tail of the queue (S17).

The manager A4 take charge of processes from, e.g., S18 onward. The manager A4 starts processing from the head of the queue (S18). Then, the manager A4 acquires the acquisition value, associated with the item of the head of the queue, in the information table, and hands over the processing to the GUI (S19). As a result, the acquisition value is displayed on the management screen on the GUI. The manager A4 reflects a processing result in the information table (S20). More specifically, the manager A4 clears, e.g., the change flag of the associated item in the information table. The manager A4 further reflects the changed element in a given file serving as a saving file of the information table (S21). The manager A4 executes the processes in S18-S20 by way of one example of a screen control unit.

Note that the data acquiring unit A3 sets, as described above, the acquired value in the “information acquisition value” field of the information table or sets ON the change flag when the acquired value is not coincident with the value registered in the “present value” field of the information table in S14. Then, the data learning unit A2 adds the process to the queue in accordance with the setting of the information acquisition value or the setting of the change flag. The manager A4 executes the process in S19 on the premise of the process in S14 by the data acquiring unit A3 and the processes in S15-S17 by the data learning unit A2. The manager executes the process in S19 as one example of a process of updating information in the associated display field on the screen when item information acquired by an information acquiring unit is different from the information displayed in the associated display field on the screen.

<Process of Data Acquiring Unit>

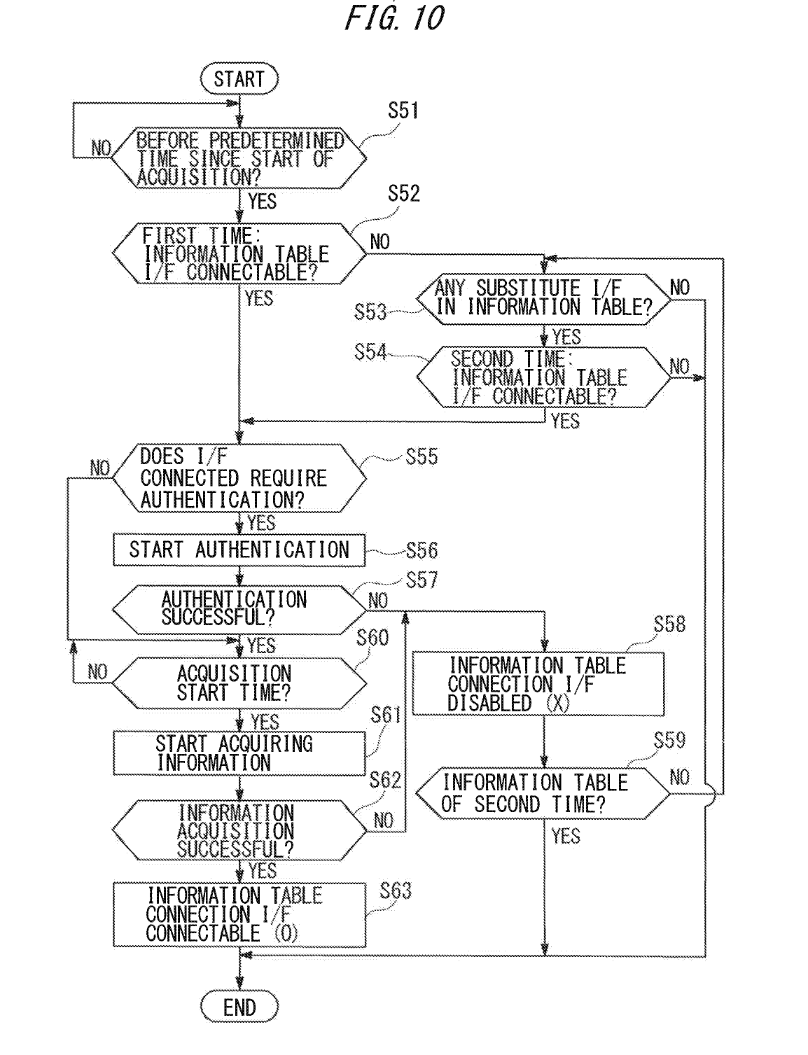

FIG. 10 is a flowchart illustrating details of processes of the data acquiring unit A3. The data acquiring unit A3 checks whether the connection I/F specified by the item in the information table is connectable. This check is also called an alive check. When the connection I/F is connectable, the data acquiring unit A3 starts establishing the connection and thus acquires the information. The data acquiring unit A3 acquires the data from the individual layers by use any one of a plurality of connection interfaces I/F including the general connection I/F and the substitute I/F. There being the connection I/F requiring the time for the authentication of the OS and other equivalent software, the data acquiring unit A3 previously establishes a connection to the connection I/F earlier than the connection timing set in the information table in the case of using the specified connection I/F, and previously sets the information obtainable immediately after issuing an acquisition instruction. The data acquiring unit A3 feeds back usability of the connection I/F to the information table each time.

FIG. 10 illustrates further detailed processes of the processes in S5-S14 of FIG. 9. The data acquiring unit A3 monitors by use of, e.g., a timer and other equivalent devices whether the connection is established earlier by a given period of time than the acquisition timing determined by the time interval specified in the “interval” field in the information table (S51). Note that the given period of time being set earlier may be several seconds and may also be several minutes. For example, the information processing system has less of issues about the resources and the load, in which case the data acquiring unit A3 may connect to the connection I/F beforehand, and may also adjust the timing for acquiring the information through monitoring the time by the timer and other equivalent devices. The data acquiring unit A3 determines whether the general connection I/F in the information table is connectable or not (S52). Herein, according to the embodiment, the general connection I/F is referred to as the connection I/F of the first time, while the substitute I/F is referred to as the connection I/F of the second time.

When determining in S52 that the general connection I/F is not connectable, the data acquiring unit A3 determines whether the substitute I/F is defined or not (S53). When the substitute I/F is not defined, the data acquiring unit A3 reflects the same result as in S13 of FIG. 9 in the information table, and the processing is ended.

Whereas when determining in S53 that the substitute I/F is defined, the data acquiring unit A3 determines whether the substitute I/F is connectable or not (S54). When the substitute I/F is not connectable, the data acquiring unit A3 reflects the same result as in S13 of FIG. 9 in the information table, and the processing is ended. The data acquiring unit A3 executes the processes in S52-S54 as one example of the process about the acquisition path being configured redundant.

When determining in S52 or S53 that any one of the connection I/Fs is connectable, the data acquiring unit A3 refers to the items of the information table, and thus determines whether the connection I/F determined to be connectable requires the authentication or not (S55). When determining in S55 that the authentication is required, the data acquiring unit A3 starts the authentication for the connection I/F (S56). The data acquiring unit A3 executes the processes in S55-S56 by way of one example of a process of completing authentication for an acquisition path.

Then, the data acquiring unit A3 determines whether the authentication is successful or not (S57). When determining in S57 that the authentication becomes a failure, the data acquiring unit A3 sets the “connection-disabled” status about the connection I/F with which to start the authentication of the relevant item in the information table (S58).

The data acquiring unit A3 further determines whether or not the connection I/F determined to fail in the connection in S57 is the substitute I/F, i.e., the connection I/F of the second time (S59). When determining that the connection I/F determined to fail in the connection in S57 is not the substitute (second time) connection I/F, the data acquiring unit A3 advances the processing to S53, and checks whether the substitute (second time) connection I/F exists or not. Whereas when determining that the connection I/F determined to fail in the connection in S57 is the substitute (second time) connection I/F, the data acquiring unit A3 ends the process. The data acquiring unit A3 executes the processes in S57-S59 as one example of the process about the acquisition path being configured redundant.

Whereas when determining in S57 that the authentication becomes successful, the data acquiring unit A3 waits up to acquisition start time defined by the time interval specified in the “interval” field of the information table (S60). The data acquiring unit A3 executes the process in S60 as one example of the process of acquiring the respective items of information at the update timing corresponding to the classification.

Upon the acquisition start time being reached, the data acquiring unit A3 starts acquiring the information from the connection I/F (S61). The data acquiring unit A3 determines whether the information acquisition becomes successful or not (S62). When the information acquisition does not become successful, the data acquiring unit A3 advances the processing to S58 and sets the connection I/F in the connection-disabled status in the information table and determines whether the I/F is the substitute I/F or not. Whereas when the information acquisition becomes successful in S62, the data acquiring unit A3 sets the acquired information in the information table, and sets the connection I/F in a connectable status in the information table (S63). The data acquiring unit A3 conducts the same reflection in the information table as in S14 of FIG. 9, and the processing is ended.

<Processes of Data Learning Unit>

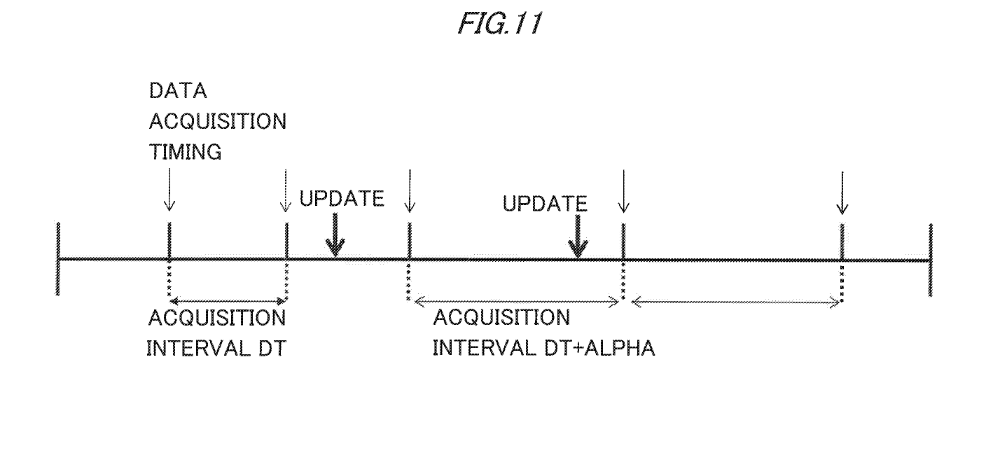

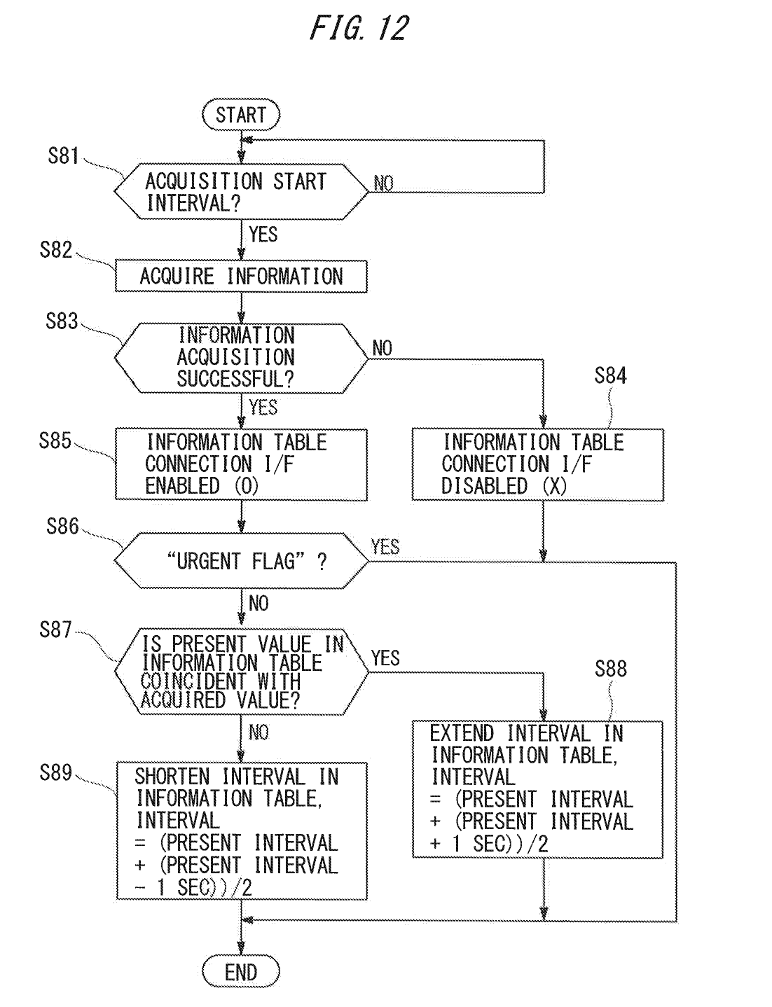

Processes of the data learning unit A2 will hereinafter be described with the reference to FIGS. 11 and 12. The data learning unit A2 learns a proper acquisition interval about items of information enabling the acquisition interval to be learnt. The data learning unit A2 sets the learnt acquisition interval in the “interval” field of the information table so that the data acquiring unit A3 acquires the information at the learnt acquisition interval. In other words, the data learning unit A2 hands over the acquisition interval to the data acquiring unit A3 by setting the learnt acquisition interval in the information table. Note that the data acquiring unit A3, as described in FIG. 10, previously implements the authentication of the connection I/F with respect to the time interval set in the “interval” field of the information table, and sets the information obtainable together with the issuance instruction.

The information table provides three categories of classifications of the respective information acquisition target items in the embodiment. The three categories of classifications are (1) an item set as an update interval learning target, (2) an item with information being acquired at a fixed interval and (3) an item not set as the update interval learning target. The data learning unit A2 learns the information acquisition interval according to the classifications in the information table. The data learning unit A2 feeds back characteristics of the respective items to the information table in accordance with an acquired result of the information.

(1) Update Interval Learning Target Information;

Update interval learning target information is an item of information assumed not to require the information acquisition in a short period of time (instanced by a minute scale and other equivalent scales). The urgent flag is not set in the update interval learning target item.

The update interval learning target information is information on the hardware layer, the OS layer, the virtual layer and other equivalent layers. Information presumed to be updated and to change the status according to a fixed action as instanced by changing the information due to power ON/OFF, is classified into the category of the update interval learning target information.

FIG. 11 illustrates an update interval learning procedure. The management apparatus previously sets an initial value of the information acquisition interval in the information table. The data learning unit A2 collects the information at the interval of the initial value being initially set in the information table. Upon an elapse of the acquisition interval, the acquisition of the information via the connection I/F is started. When the present value retained in the information table is the same as the acquisition value acquired via the connection I/F, the acquisition interval is extended, and, e.g., an average value of the present acquisition interval and the acquisition interval of the last time is set as a next acquisition interval. The information acquisition interval of the data learning unit A2 is not therefore fixed for the update interval learning target information, and next information acquisition timing is determined by the acquisition interval of the last time (i.e., the present value in the information table).

On the other hand, when the power is switched ON/OFF because of a high possibility of many items being updated through the power ON/OFF, it may be sufficient that the data learning unit A2 acquires the data via the connection I/F even at the timing other than the acquisition timing specified by the acquisition interval.

FIG. 12 is a flowchart illustrating an update interval learning procedure. The data acquiring unit A3 takes charge of processes in S81 through S86, while the data learning unit A2 takes charge of processes in S87 through S89 in FIG. 12. The data learning unit A2 executes the processes in S87-S89 as one example of a setting unit. Note that FIG. 12 omits the monitoring (S51 in FIG. 10) for the preliminary connection process for the connection I/F requiring the time for the authentication illustrated in FIG. 10 and also the information acquisition (S10-S13 in FIG. 9, S53-S54 in FIG. 10, and other equivalent processes) via the substitute I/F.

The data acquiring unit A3 waits up to the information acquisition start timing determined by the time interval specified in the “interval” field of the information table in the process of FIG. 12 (S81). The data acquiring unit A3 executes the process in S81 by way of one example of a process of acquiring each item of information at update timing corresponding to the classification.

When reaching the information acquisition start timing, the data acquiring unit A3 acquires the information from the connection I/F defined in the information table (S82). Then, the data acquiring unit A3 determines whether the information acquisition becomes successful or not (S83). When failing in acquiring the information, the data acquiring unit A3 sets the connection-disabled status for the connection I/F defined in the information table (S84), and the processing is ended. Whereas when the information acquisition becomes successful, the data acquiring unit A3 sets the connectable status for the connection I/F defined in the information table (S85).

The data acquiring unit A3 determines whether or not the urgent flag is set in the information acquisition target item (S86). When the urgent flag is set in the information acquisition target item, the data acquiring unit A3 finishes processing.

Next, the data learning unit A2 adjusts the information acquisition interval. The data learning unit A2 determines whether the present value in the information table is coincident with the information acquisition value or not (S87). The information acquisition value is herein an acquisition value of the information acquired at the acquisition interval determined by the process in S81. The phrase “the present value in the information table being coincident with the information acquisition value” connotes that the information acquisition value acquired at the acquisition interval determined by the process in S81 does not change. This connotation being thus made, when the determination in S87 is “NO”, i.e., when the information acquisition value changes, the data learning unit A2 shortens the information acquisition interval in a given procedure (S89). For example, the data learning unit A2 may decrease the information acquisition interval by a given value. The data learning unit A2 may also decrease the information acquisition interval at a given rate. The data learning unit A2 executes the processes in S87-S89 as one example of a process of determining whether the information changes and setting timing for acquiring each item of information corresponding to whether the change occurs.

Whereas, when the determination in S87 is “YES”, the data learning unit A2 increases the information acquisition interval in a given procedure (S88). For example, the data learning unit A2 may increase the information acquisition interval by a given value. The data learning unit A2 may further increase the information acquisition interval by a given rate.

Note that the data learning unit A2 may execute a statistic process instanced by measuring a period for which the information acquisition interval changes a given number of times and obtaining an average value of measured values in the processes of S87 and S88. The data learning unit A2 may subsequently set a value given by executing the statistic process of the average value and other equivalent values in the “interval” field of the information table.

(2) Information Acquired at Fixed Interval;

The “information acquired at the fixed interval” is exemplified by the CPU usage ratio, the memory usage ratio, a disk usage ratio, an event log count and other equivalent information in the information table of FIG. 8. A power value is also exemplified as an item excluding the items given in the information table of FIG. 8. The data acquiring unit A3 collects these items of information at the fixed time interval, and the manager A4 calculates and displays, e.g., the statistical value instanced by the average value on the management screen.

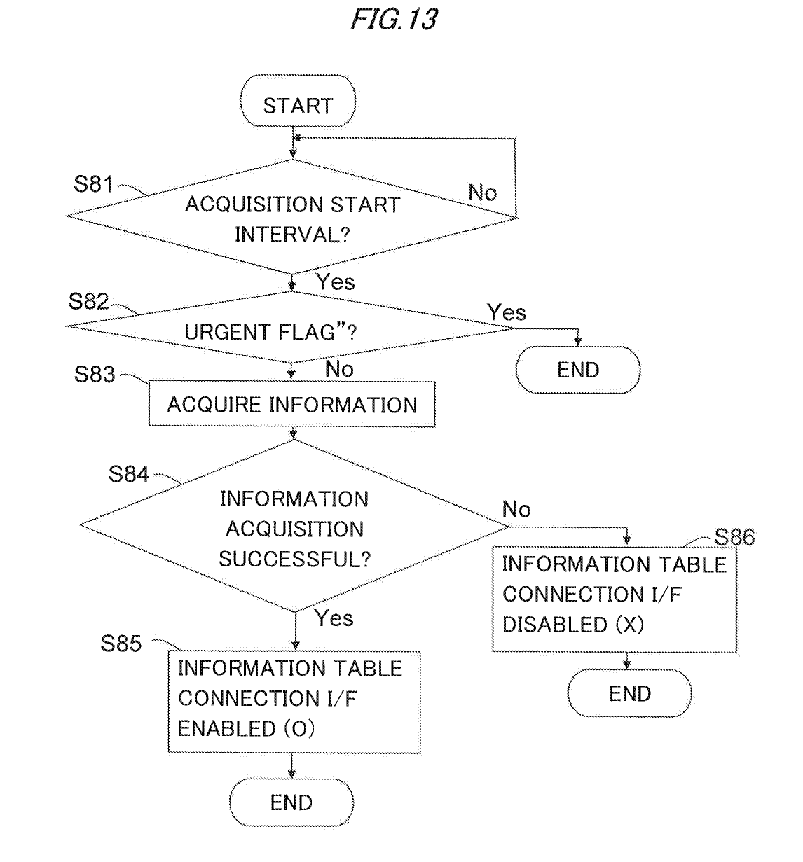

FIG. 13 is a flowchart illustrating processes of acquiring the information at the fixed interval. The processes in FIG. 13 are the same as the processes in FIG. 12 except a point that the processes (S87-S89) by the data learning unit A2 are omitted as compared with the processes in FIG. 12. This being the case, the same processes as the processes in FIG. 12 are marked with the same numerals and symbols in FIG. 13. To be specific, the data acquiring unit A3 acquires, as the information to be acquired at the fixed interval, the information at the information acquisition start timing determined by the time interval specified in the “interval” field in the information table except the case of the urgent flag being set (NO in S82). The data acquiring unit A3 sets the acquired information in the information table (S83). The data acquiring unit A3 further sets the connection-enabled status or the connection-disabled status of the connection I/F in the information table (S85, S86).

(3) Update Interval Learning Non-Target Item (Information to be Changed Accidentally);

Information to be changed accidentally may be exemplified by a status or an event log and other equivalent information. The urgent flag is set in an item of information to be changed accidentally, and the information is acquired based on the urgent flag. Note that the management apparatus may predict a fault in a fault prediction process, and may monitor the information in relation to the information to be changed accidentally as instanced by information about a fault of the hardware.

<Screen Update Process>

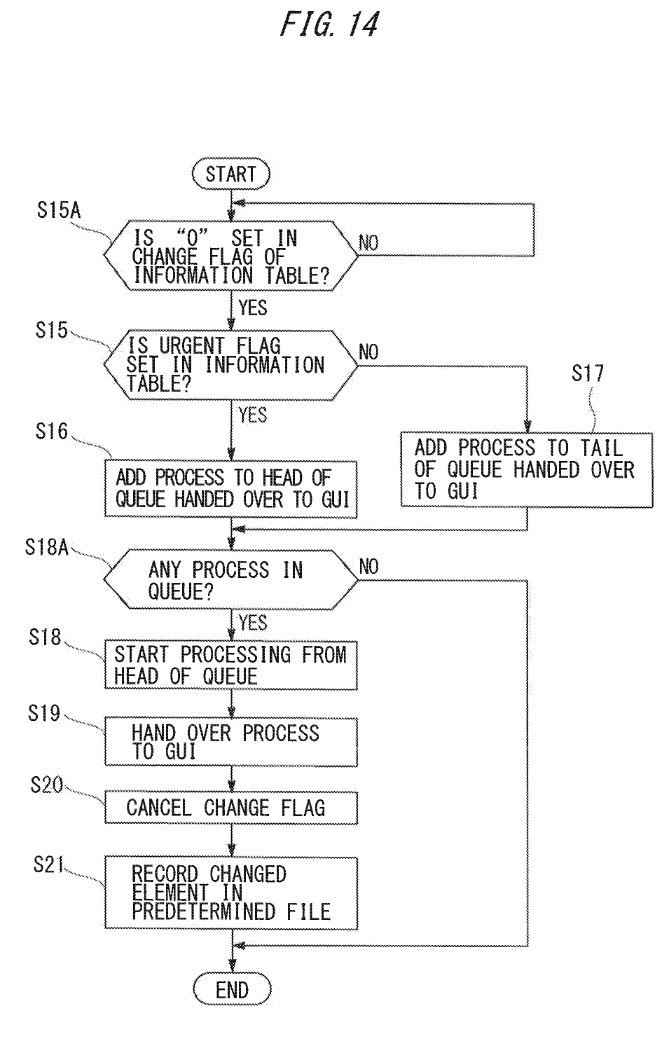

FIG. 14 is a flowchart illustrating a screen update process in detail. Processes in FIG. 14 are processes into which the processes from S15 onward in FIG. 9 are concretized. The same processes in FIG. 14 as the processes in FIG. 9 are marked with the same numerals and symbols. The data learning unit A2 and the manager A4 execute the processes in FIG. 14. The data learning unit A2 waits for the data acquiring unit A3 to update the change flag in the processes of FIG. 14 (S15A). However, the data learning unit A2 may, as already explained in FIG. 9, monitor whether a value other than “Blank” or “NULL value” is set as the information acquisition value in the information table.

Upon the change flag being updated, the data learning unit A2 determines whether the urgent flag is set in the information table or not (S15). When the urgent flag is set in the item having the active status of the processing in the information table, the data learning unit A2 adds the process to the head of the queue (S16). Whereas when the urgent flag is not set in the item having the active status of the processing in the information table, the data learning unit A2 adds the process to the tail of the queue S17.

The manager A4 takes charge of processes from S18A onward. The manager A4 determines whether the process exists in the queue or not (S18A). When the process does not exist in the queue, the manager finishes processing. Whereas when the process exists in the queue, the manager A4 hands over the information acquisition value in the information table to the GUI according to the procedure in S18-S21. The GUI reflects the information acquisition value handed over from the manager A4 in the management screen. The manager A4 outputs a changed element to a given file. The procedure in S18-S21 is the same as the procedure in FIG. 9, and hence a detailed description thereof is omitted.

<Process when Starting Up Application>

The API outputs the values of the updated information table also to the given file corresponding to the information table at update timing of the information table. The values of the file corresponding to the information table are therefore rewritten along with updating the information table. The management apparatus reads the file corresponding to the information table, and sets the values read from the file in the information table when starting up the application next time. Accordingly, it follows that the data acquiring unit A3 and the data learning unit A2 of the API update differences from the values read from the file on and after the startup of the application. Note that the given file corresponding to the information table is also called the setting condition file.

FIG. 15 is a flowchart illustrating processes when starting up the application. Processes in FIG. 15 are processes into which the processes in S2 through S3 in FIG. 9 are concretized. The same processes in FIG. 15 as the processes in FIG. 9 are marked with the same numerals and symbols. The CPU 11 of the management apparatus starts the application as described in FIG. 9 (S2). The CPU 11 of the management apparatus further starts the service (S3). The application, thereupon, starts up the initializing process of the API (S3A). The initializing process of the API involves determining whether the setting condition file is saved in a given directory (folder) or not (S3B). When the determination in S3B is “YES”, the initializing process of the API involves reading the values in the setting condition file, setting the readout values in the information table, and handing over the values in the setting condition file to the GUI (S3D). Whereas when the determination in S3B is “NO”, the initializing process of the API involves newly generating a setting condition file (S3C). The GUI does not take over the values in the setting condition file in the instance of S3E, with the result that the initial values (default values) in the information table remain unchanged on the management screen on the GUI. The GUI thereafter deploys the screen and outputs the deployed screen to the display device 16 (S3E).

### Effect of Embodiment

(1) The management apparatus generates the information table and starts collecting the information irrespective of whether the management screen is displayed when starting up the service for providing the management information. The information is therefore reflected in the management screen smoothly and quickly.

(2) The data acquiring unit A3 of the management apparatus sets the change flag when the change occurs in the information of the management target item of the management target apparatus, and the data learning unit A2 sets, in the processing queue, the process of the information acquisition value depending on whether the change flag is set, and hands over the process to the manager A4. As a result, when the change occurs in the information of the management target item, the manager A4 hands over the information acquisition value to the GUI, and the management screen on the GUI is updated. The manager A4 further resets the value of the change flag after updating the management screen with the information acquisition value acquired from the management target apparatus. The GUI takes over the information of the item with the difference being caused in the management target items through this procedure, thereby reducing a traffic between the API and the GUI and also the load on the network.

(3) The data learning unit A2 extends or shortens the interval for acquiring the information, corresponding to whether the change occurs in the information acquisition value acquired by the data acquiring unit A3. The management apparatus is therefore enabled to acquire the information at the proper timing in accordance with the characteristics of the information acquired from an information acquisition source.

In other words, the data learning unit A2 sets the timing for acquiring the information set as the target for learning the information acquisition interval. On the other hand, the data acquiring unit A3 acquires the information at the fixed interval without reflecting a learning result by the data learning unit A2 in the information to be acquired at the fixed interval. The data acquiring unit A3 further acquires the information without setting, as the learning target, the information with the urgent flag being set, and hands over the acquired information preferentially to the GUI. Thus, the information acquisition unit A3 of the information processing system according to the embodiment can, with the information being classified corresponding to the characteristic per information acquisition target item, acquire each item of information at the update timing corresponding to the classification thereof.

The process corresponding to the classification described above enables the information to be acquired at the update timing corresponding to a property of the management target item, and the resource load is therefore distributed when updating. Situations instanced by a stop of updating the management screen for a long period of time and by a frozen screen are consequently restrained from occurring. The processing time for displaying the screen is also reduced.

(4) The manager A4 outputs the information acquisition value in the information table also to the given file corresponding to the information table at the timing for updating the management screen. Application of the management apparatus, upon the startup of the next time, reads the given file and reflects the contents of the given file in the information table, updates the information table on the basis of the saved contents, and displays the information on the management screen on the GUI. For example, the contents learnt by the data learning unit A2 are accordingly reflected in the processes from the next time onward.

(5) The management apparatus gives the redundancy to the path related to the information acquisition. The management apparatus acquires the information from the substitute interface when the information cannot be acquired from the connection I/F but when the substitute I/F exists. The use of the substitute I/F enables the GUI to acquire the information from the substitute I/F even when the communication-disabled status occurs.

(6) The data acquiring unit A3 of the management apparatus determines the information acquisition method of this time by taking account of the status when acquiring the information last time, the status being instanced by the obtainability of the information from each connection I/F, and other equivalent statuses. The data acquiring unit A3 of the management apparatus reflects the status of this time in the information table. The statuses when acquiring the information in the past are reflected in the process of the next time.

(7) The data acquiring unit A3 of the management apparatus performs the authentication process for the connection I/F required to be authenticated before collecting the information. The authentication therefore restrains the information acquisition from being delayed.

(8) The information about the parameter prompted to be reflected in displaying the screen as instanced by an error is handed over preferentially to the GUI via the urgent flag, and is displayed.

(9) The processes described above lead to difficulty of the occurrence of the timeout, which further leads to a reduction in time till acquiring the information in the management software.

<Non-Transitory Computer-Readable Recording Medium>

A program for making a computer, other machines and devices (which will hereinafter be referred to as the computer etc) realize any one of the functions can be recorded on a non-transitory recording medium readable by the computer etc. Then, the computer etc is made to read and execute the program on this recording medium, whereby the function thereof can be provided.

Herein, the recording medium readable by the computer etc connotes a recording medium capable of accumulating information such as data and programs electrically, magnetically, optically, mechanically or by chemical action, which can be read by the computer etc. Among these recording mediums, for example, a flexible disc, a magneto-optic disc, a CD-ROM, a CD-R/W, a DVD, a Blu-ray disc, a DAT, an 8 mm tape, a memory card such as a flash memory, etc are given as those removable from the computer. Further, a hard disc, a ROM (Read-Only Memory), etc are given as the recording mediums fixed within the computer etc. Further, SSD (Solid State Drive) is usable as any of the recording mediums removable from the computer etc. and the recording mediums fixed within the computer etc.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such example in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An information processing apparatus comprising
a processor, and
a memory storing a program, the program causing the processor to execute:
acquiring one or more items of information from one or more connection interfaces each to access an information acquisition source within an information processing system at timing being set corresponding to each item;
displaying each item of the acquired one or more items information in a display field associated with each item of the acquired one or more items information; and
setting the timing for acquiring the one or more items of information next corresponding to a characteristic per item of the acquired one or more items information.

2. The information processing apparatus according to claim 1, wherein the setting includes determining whether a change occurs in any item of the acquired one or more items of information, and setting the timing for acquiring each item of the one or more items of information next corresponding to whether the change occurs.

3. The information processing apparatus according to claim 1, wherein the acquiring an item of information includes acquiring the item of information without depending on whether the item of information is displayed on the screen.

4. The information processing apparatus according to claim 1, wherein the displaying includes updating the information displayed in the associated display field on the screen when the item of information acquired is different from the information displayed in the associated display field on the screen.

5. The information processing apparatus according to claim 1, wherein an information acquisition path based on a combination of the information acquisition source and the connection interface is configured redundant for at least one item in the one or more items of information.

6. The information processing apparatus according to claim 1, wherein the acquiring an item of information includes completing authentication for an information acquisition path before timing set corresponding to the item, the information acquisition path being required to be authenticated for accessing based on the combination of the information acquisition source and the connection interface.

7. An information processing method, comprising:
acquiring one or more items of information from one or more connection interfaces each to access an information acquisition source within an information processing system at timing being set corresponding to each item;
displaying each item of the acquired one or more items information in a display field associated with each item of the acquired one or more items information; and
setting the timing for acquiring the one or more items of information next corresponding to a characteristic per item of the acquired one or more items information.

8. The information processing method according to claim 7, wherein the setting includes determining whether a change occurs in any item of the acquired one or more items of information, and setting the timing for acquiring each item of the one or more items of information next corresponding to whether the change occurs.

9. The information processing method according to claim 7, wherein the acquiring an item of information includes acquiring the item of information without depending on whether the item of information is displayed on the screen.

10. The information processing method according to claim 7, wherein the displaying includes updating the information displayed in the associated display field on the screen when the item of information acquired is different from the information displayed in the associated display field on the screen.

11. The information processing method according to claim 7, wherein an information acquisition path based on a combination of the information acquisition source and the connection interface is configured redundant for at least one item in the one or more items of information.

12. The information processing method according to claim 7, wherein the acquiring an item of information includes completing authentication for an information acquisition path before timing set corresponding to the item, the information acquisition path being required to be authenticated for accessing based on the combination of the information acquisition source and the connection interface.

13. A computer-readable non-transitory storage medium storing a program to cause a computer to execute:
acquiring one or more items of information from one or more connection interfaces each to access an information acquisition source within an information processing system at timing being set corresponding to each item;
displaying each item of the acquired one or more items information in a display field associated with each item of the acquired one or more items information; and
setting the timing for acquiring the one or more items of information next corresponding to a characteristic per item of the acquired one or more items information.

14. The computer-readable non-transitory storage medium according to claim 13, wherein the setting includes determining whether a change occurs in any item of the acquired one or more items of information, and setting the timing for acquiring each item of the one or more items of information next corresponding to whether the change occurs.

15. The computer-readable non-transitory storage medium according to claim 13, wherein the acquiring an item of information includes acquiring the item of information without depending on whether the item of information is displayed on the screen.

16. The computer-readable non-transitory storage medium according to claim 13, wherein the displaying includes updating the information displayed in the associated display field on the screen when the item of information acquired is different from the information displayed in the associated display field on the screen.

17. The computer-readable non-transitory storage medium according to claim 13, wherein an information acquisition path based on a combination of the information acquisition source and the connection interface is configured redundant for at least one item in the one or more items of information.

18. The computer-readable non-transitory storage medium according to claim 13, wherein the acquiring an item of information includes completing authentication for an information acquisition path before timing set corresponding to the item, the information acquisition path being required to be authenticated for accessing based on the combination of the information acquisition source and the connection interface.
